(19) United States
(12) Patent Application Publication
(10) Pub. No.: US 2014/0347350 A1
(43) Pub. Date: Nov. 27, 2014

(54) Image Processing Method and Image Processing System for Generating 3D Images

(71) Applicant: HTC Corporation, Taoyuan County (TW)

(72) Inventors: Fu-Chang Tseng, Taoyuan County (TW); Jing-Lung Wu, Taoyuan County (TW); Hsin-Ti Chueh, Taoyuan County (TW)

(73) Assignee: HTC Corporation, Taoyuan County (TW)

(21) Appl. No.: 13/900,550

(22) Filed: May 23, 2013

(51) Int. Cl. G06T 15/00

(52) U.S. Cl. CPC G06T 15/00
USPC 345/419

(57) ABSTRACT

An image processing method for generating 3D images is disclosed. The image processing method comprises: capturing a first image of a first resolution and a second image of a second resolution, the first image and the second corresponding to a same scene; scaling the first image to a third image in the second resolution; analyzing the third image and the second image to determine an image offset between the third image and the second image; duplicating the first image; applying the image offset to the duplicated first image; and providing the first image and the duplicated first image for displaying on a 3D display unit; wherein the first resolution is higher than the second resolution.

### BACKGROUND OF THE INVENTION

1. Field of the Invention

The present invention relates to an image processing method and an image processing system for generating 3D images from source images of different resolutions. 3D image disparity is determined on down-scaled images in lower resolution and be restored back on high resolution images.

2. Description of the Prior Art

Typically, 3D display is implemented by displaying two images of the same scene with fixed disparities at the same time, right images for the right eye and left images for the left eye. To create the 3D effect, the right images should be only visible to the right eye and the left images are only visible to the left eye. A common 3D display device is provided with eye goggle that should be worn by user while viewing 3D images. The right lens of the goggle is designed to filter out the left images so that user's right eye would not see the left images, and vice versa. In another conventional system, the display screen is provided with barrier separating viewing angles of the right images and left images so as to eliminate the need of eye goggle. However, both implementations require separate source images for the right eye and left eye. 3D image capture or recording conventionally is achieved by dual lens camera in which the right lens module captures right images and the left lens module captures left images. The two lens modules are disposed with fixed distance away so that the right images and the left images would correspond to the same scene with disparity. However, the cost of camera lens module goes up with the maximum resolution supported. Implementing an image capture device supporting 3D image capture and generation in high resolution might increase hardware cost.

### SUMMARY OF THE INVENTION

The present invention discloses an image processing system and an image processing method for generating 3D images. According to one aspects of the invention, an image processing method for generating 3D images is disclosed. The image processing method comprises: capturing a first image of a first resolution and a second image of a second resolution, the first image and the second corresponding to a same scene; scaling the first image to a third image in the second resolution; analyzing the third image and the second image to determine an image offset between the third image and the second image; duplicating the first image; applying the image offset to the duplicated first image; and providing the first image and the duplicated first image for displaying on a 3D display unit; wherein the first resolution is higher than the second resolution.

According to another aspect of the invention, an image processing system for generating 3D images is disclosed. The image processing system comprises: a first sensor, configured to capture at least a first image of a first resolution; a second sensor, configured to capture at least a second image of a second resolution which is lower than the first resolution; an image processing unit, configured to scale the first image into the second resolution, determine an image offset between the scaled first image and the second image, duplicate the first image and apply the image offset to the duplicated first image; and a display unit, configured to display the first image and the duplicated first image simultaneously in 3D manner.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an image processing system according to one embodiment of the present invention.

FIG. 2 illustrates an image processing method for generating 3D images according to one embodiment of the present invention.

FIG. 3 illustrates an image processing method for generating 3D images according to another embodiment of the present invention.

### DETAILED DESCRIPTION

For preventing the processing delay in a 3D image displaying system, the present invention discloses an image processing method and an image processor applying the image processing method for providing 3D display of source images with different resolutions. By performing image analysis on lower resolution images and applying the analysis result on higher resolution images, an effective 3D image processing system/method is achieved with reduced hardware cost in the invention.

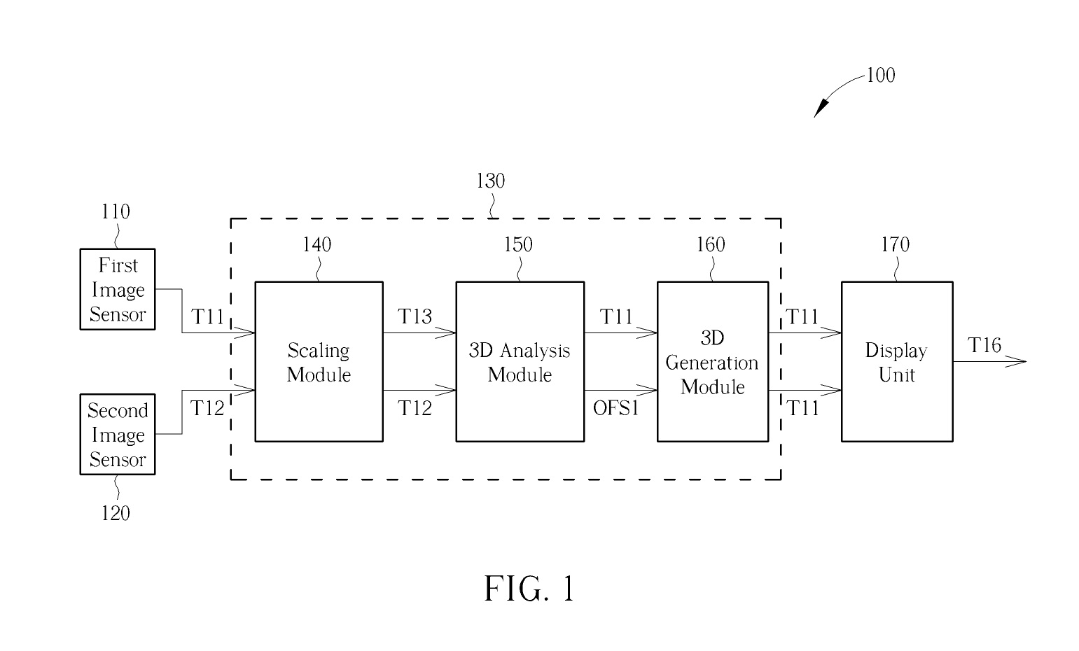

Please refer to FIG. 1, which illustrates an image processing system 100 according to one embodiment of the present invention. As shown in FIG. 1, the image processing system 100 comprises a first image sensor 110, a second image sensor 120, an image processing unit 130 and a display unit 170. The image processing unit 130 comprises a scaling module 140, a 3D analysis module 150, and a 3D generation module 160.

The first image sensor 110 and the second image sensor 120 are configured to capture source images for the right images and the left images to be displayed on the display unit 170 respectively. The first image sensor 110 is configured to capture a first image T11 of a first resolution, and the second image sensor 120 is configured to capture a second image T12 of a second resolution. In embodiments of the invention, the first resolution is different from or is not equal to the second resolution. However, the first image sensor 110 and the second image sensor 120 are configured to capture images at a same frame rate. To the ease of description, in the embodiment here, the first resolution is assumed to be higher than the second resolution.

The scaling module 140 is configured to rescale the resolution and/or size of the first image T11 and the second image T12. As described above, a 3D image display requires a pair of right images and left images with proper disparity. Since the source images captured from the first image sensor module 110 and the second image sensor module 120 are of different resolutions, the source images should be rescaled to the same resolution for analyzing corresponding disparity between the scaled images, and the disparity is applied to another pair of images of the same but higher resolution used for display to provide the right images and the left images. The scaling module 140 may down scale the first image T11 to generate a third image T13 whose resolution is the same as the second image T12, i.e. the second resolution. In another embodiment of the invention, the scaling module 140 may down scale both the first image T11 and the second image T12 to generate a pair of images in a third resolution which might be lower than the second resolution. That means, the first image T11 and the second image T12 are down-scaled by different ratios . The scaled image pair in the third resolution is sent to the 3D analysis module 150 for further processing.

The 3D analysis module 150 is configured to perform feature analysis on a pair of images to determine image offset between the pair of images. In the embodiment of FIG. 1, the 3D analysis module 150 performs analysis on the second image T12 and the third image T13 of the second resolution. In one embodiment of the invention, the 3D analysis module 150 performs feature extraction and/or feature mapping on the second image T12 and the third image T13 to determine corresponding features. The image offset can thus be determined by calculating differences between corresponding features. And the image offset comprises at least one of the following: location offset, depth offset, color offset, etc. The result of the 3D analysis module 150 is sent to the 3D generation module 160. The 3D generation module 160 receives the high resolution source images, which is the first image T11 from the first image sensor 110 in this embodiment, and generates a pair of output images according to the image offset for right view and left view of the display unit 170. The 3D generation module 160 duplicates the first image T11 and applies the image offset to the duplicated first image T11′. For example, in the case that the first image sensor 110 is designed to provide right images and the second image sensor 120 is designed to provide left images, the first image T11 is provided to the display unit 170 as the right image and the duplicated first image T11′ is outputted to the display unit 170 as the left image. In this way, a high resolution 3D image can be provided and displayed to the user even though one of the image sensors can only provide low resolution source images.

The 3D generation module 160 may shift pixel positions of the duplicated first image T11′ by an offset, adjust depths and colors of the pixels so that the duplicated first image T11′corresponds to an up-scaled version of the second image T12. That is to say, the disparity of the third image T13 and the second image T12 is reflected on the first image T11 and the duplicated first image T11′. Yet in another embodiment of the invention, the first image T11 can be scaled to another resolution lower than the first resolution but higher than the second resolution. Similarly, the scaled first image is duplicated and applied with the image offset so as to generate a pair of images with desired disparity. In the latter case, the image offset may be further scaled according to the ratio between the first image and the scaled first image. Analyzing images in lower resolution provides the benefits of reducing computation complexity and thus improving efficiency, and reducing hardware cost of expensive high resolution image sensor.

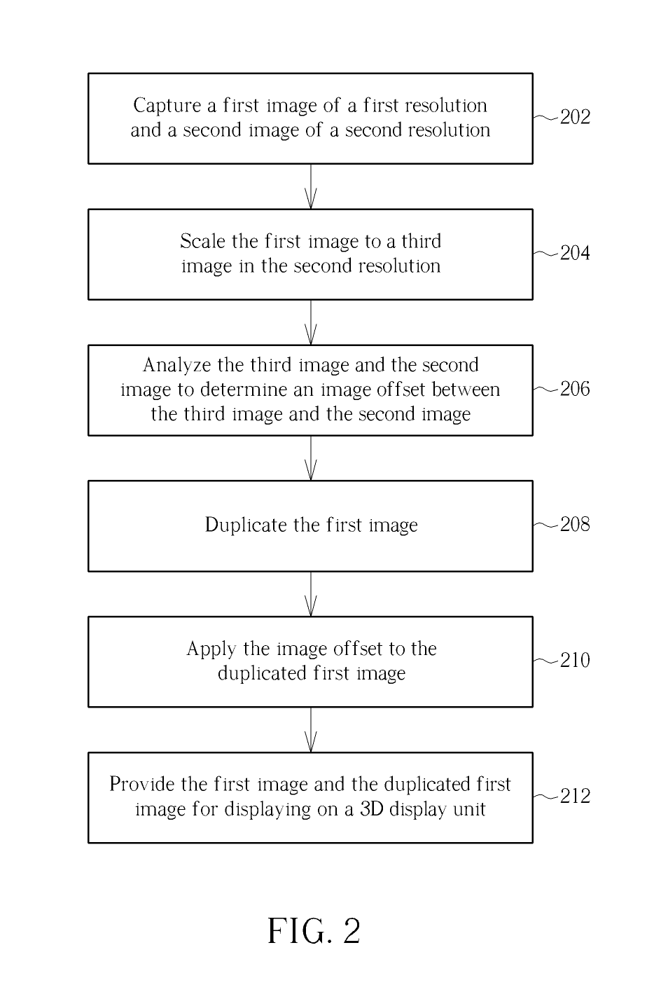

Please also refer to FIG. 2. FIG. 2 illustrates an image processing method for generating 3D images according to one embodiment of the present invention. The image processing method can be implemented by the image system of FIG. 1. The image system may be embodied in a portable electronic device, such as a mobile phone, tablet digital camera/camcorder, multimedia device, game console, and/or other suitable devices supporting 3D image display or generation. Here in the embodiment, 3D images in high resolution are generated from source images of different resolutions. The 3D disparity can be determined from source images in lower resolution and be restored back on images in high resolution. As shown in FIG. 2, the image processing method comprises steps as the following:

Step 202: Capture a first image of a first resolution and a second image of a second resolution. The first image and the second image correspond to right view and left view of a scene in 3D mode, and can be captured by a first image sensor and a second image sensor respectively. The first image sensor and the second image sensor may operate at the same frame rate, and capture the first image and the second image simultaneously for creating 3D view of the scene. To provide 3D image capture, the first image sensor and the second image sensor are placed separately with predetermined distance, similar to the eyes position of human. The distance between the image sensors provides disparity in images captured by the image sensors. In the embodiment of FIG. 2, the first resolution is assumed to be higher than the second resolution.

Step 204: Scale the first image to a third image in the second resolution. For the purpose of generating 3D viewing in high resolution, 3D disparity needs to be determined first. Thus, the first image of the higher resolution is down scaled to the lower resolution. By performing analysis in lower resolution images, computation efficiency can also be increase.

Step 206: Analyze the third image and the second image to determine an image offset between the third image and the second image. To determine difference between the images, feature extraction and/or feature mapping may be performed to find corresponding features in the third image (corresponding to the first image) and the second image. Pixel values of corresponding features may be compared and analyzed so as to determine the image offset. The image offset represents disparity of right view and left view in 3D mode, and may be position offset, depth offset, color offset, and/or others.

Step 208: Duplicate the first image. To construct 3D view in high resolution, the high resolution first image is duplicated and later processed for generating a high resolution view corresponding to the low resolution source image.

Step 210: Apply the image offset to the duplicated first image. The image offset may be applied by adjusting pixel values of the duplicated first image so as to generate enlarge version of the second image. Please note that the image offset may be scaled by a ratio prior to applying to the duplicated first image. The ratio would be the ratio between the first resolution and the second resolution. Since the image offset is determined in the second resolution, it should be up-scaled to reflect corresponding offset in the first resolution. Pixel values of the duplicated first image may be shifted, interpolated and/or eliminated to reflect the difference of the two views.

Step 212: Provide the first image and the duplicated first image for displaying on a 3D display unit. As described above, the first image and the second image correspond to different views in 3D mode. For example, if the first image corresponds to the right view, the duplicated first image would correspond to the left view. The first image and the duplicated first image may be display simultaneously to the user to create the 3D effect. Please also note that in other embodiment of the invention, the first image and the duplicated image may also be interleaved or interlaced to form a full 3D display image.

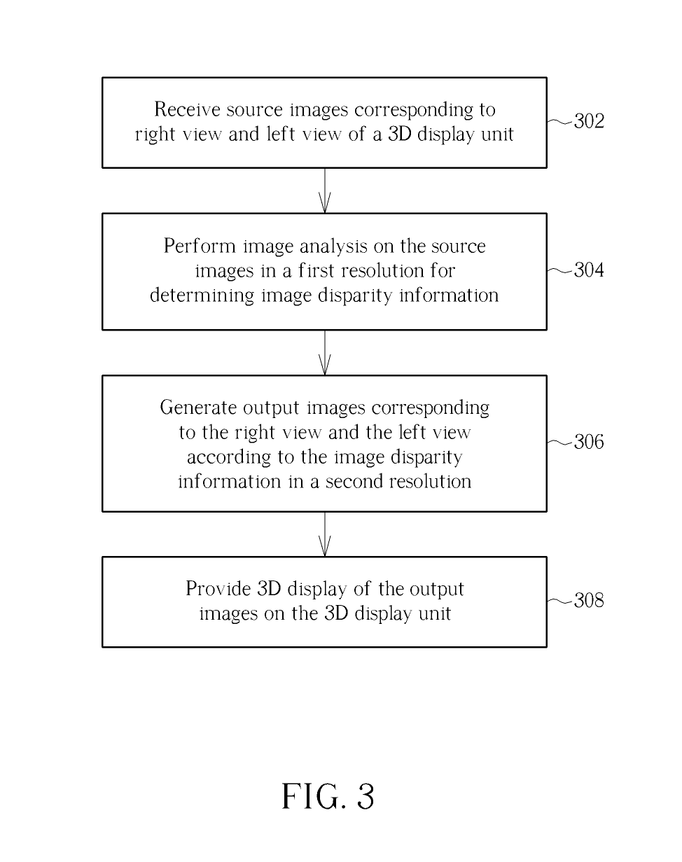

Please refer to FIG. 3. FIG. 3 illustrates an image processing method for generating 3D images according to another embodiment of the present invention. As shown in FIG. 3, the image processing method comprises steps as the following:

Step 302: Receive source images corresponding to right view and left view of a 3D display unit, the source images are of different resolution. For example, the source image corresponding to the right view may be of higher resolution than the source image corresponding to the left view. The source images may be captured by image sensors supporting different resolution.

Step 304: Perform image analysis on the source images in a first resolution for determining image disparity information. The source images are scaled to the same resolution, which may be equal to the lower resolution of the source images, or a resolution even lower. Then feature extraction and/or feature mapping are performed to determined image disparity of the source images. The image disparity information may be position offset, depth offset, color offset and/or others.

Step 306: Generate output images corresponding to the right view and the left view according to the image disparity information in a second resolution, the second resolution is higher than the first resolution. The image offset is scaled according to a ratio between the first resolution and the second resolution, and be applied to source images of higher resolution. Following above example, the image offset may be applied to the source image corresponding to the right view so as to generate output image corresponding to the left view. Yet in another example of the invention, the output images are of even higher resolution than the source images, and are generated by interpolating of the source images prior to applying the image offset.

Step 308: Provide 3D display of the output images on the 3D display unit. The output images of the second resolution is provided to and displayed on the 3D display unit. The output images may be interleaved or interlaced to form a full 3D image. In the example of this embodiment, the source image corresponding to the right view and the adjusted source image corresponding to the left view are provided as the output images.

Please note that in embodiments of the invention, the image processing method and the image processing method can be used for 3D camera shooting, video recording and/or image display. The image processing method may be implemented by suitable combination of hardware, software and firmware, for example application processor and/or image processor capable to execute software program, or dedicated circuitry. Embodiments formed by reasonable combinations/permutations of the steps shown in FIGS. 2 and 3 and/or by adding the abovementioned limitations should also be regarded as embodiments of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing method for generating 3D images, comprising:
capturing a first image of a first resolution and a second image of a second resolution, the first image and the second corresponding to a same scene;
scaling the first image to a third image in the second resolution;
analyzing the third image and the second image to determine an image offset between the third image and the second image;
duplicating the first image;
applying the image offset to the duplicated first image; and
providing the first image and the duplicated first image for displaying on a 3D display unit;
wherein the first resolution is higher than the second resolution.

2. The image processing method of claim 1, wherein the first image corresponds to one of a right view and a left view of the 3D display unit, and the second image and the duplicated first image correspond to the other view of the 3D display unit.

3. The image processing method of claim 1, wherein the image offset comprises one of the following: position offset, depth offset, and/or color offset.

4. The image processing method of claim 1, wherein the applying of the image offset to the duplicated first image comprises adjusting pixel values of the duplicated first image by the image offset.

5. The image processing method of claim 1, wherein analyzing of the third image and the second image is performed by feature extraction and/or feature mapping.

6. The image processing method of claim 1, wherein the capturing of the first image is performed by a first image sensor and the capturing of the second image is performed by a second image sensor, and wherein the first image sensor and the second image sensor are placed separately with a predetermined distance.

7. The image processing method of claim 6, wherein the capturing of the first image and the second image is performed simultaneously by the first image sensor and the second image sensor respectively.

8. An image system for processing 3D image, comprising:
a first sensor, configured to capture at least a first image of a first resolution;
a second sensor, configured to capture at least a second image of a second resolution which is lower than the first resolution;
an image processing unit, configured to scale the first image into the second resolution, determine an image offset between the scaled first image and the second image, duplicate the first image and apply the image offset to the duplicated first image; and
a display unit, configured to display the first image and the duplicated first image simultaneously in 3D manner.

9. The image system of claim 8, wherein the image processing unit further comprises:
a scaling module, configured to down scale the first image into the second resolution;
a 3D analysis module, configured to determine image features of the scaled first image and the second image, and to determine the image offset according to the image features;
a 3D generation module, configured to duplicate the first image and to apply the image offset to the duplicated first image.

10. The image system of claim 9, wherein the 3D analysis module is further configured to perform feature extraction and/or feature mapping to determine the image features.

11. The image system of claim 10, wherein the image offset comprise position offset, depth offset, and/or colors offset.

12. The image system of claim 9, wherein the 3D generation module is further configured to adjust pixel values of the duplicated first image according to the image offset.

13. The image system of claim 8, wherein the first image sensor and the second image sensor are configured to capture the first image and the second image concurrently at the same frame rate, and wherein the first image sensor and the second image sensor are placed separately with a predetermined distance.

14. The image processor of claim 8, wherein the first image corresponds to one of a right view and a left view of the display unit, and the second image and the duplicated first image correspond to the other view of the display unit.

15. The image system of claim 8, wherein the image system is implemented in a portable electronic device.
